(19) United States
(12) Patent Application Publication
(10) Pub. No.: US 2026/0058475 A1
(43) Pub. Date: Feb. 26, 2026

(54) ENERGY MANAGEMENT SYSTEM AND METHOD

(71) Applicant: EFLEX, INC., APEX, NC (US)

(72) Inventors: ANDREW NICHOLAS WINTER, Chapel Hill, NC (US); TREVOR GUSTOV FRANK, San Jose, CA (US); BARRY CINNAMON, APEX, NC (US)

(73) Assignee: EFLEX, INC., APEX, NC (US)

(21) Appl. No.: 19/375,747

(22) Filed: Oct. 31, 2025

Related U.S. Application Data
(63) Continuation of application No. 17/856,103, filed on Jul. 1, 2022, now abandoned.
Application No. 17/856,103 is a continuation-in-part of application No. 17/693,564, filed on Mar. 14, 2022, now abandoned.
(60) Provisional application No. 63/207,657, filed on Mar. 12, 2021.

(51) Int. Cl. H02J 3/38; G05B 19/042; H02J 3/00; H02J 3/32; H02J 13/00

(52) U.S. Cl. CPC H02J 3/381; G05B 19/042; H02J 3/007; H02J 3/32; H02J 13/00002; H02J 13/00022; G05B 2219/2639; H02J 2300/22

(57) ABSTRACT

The energy management system and method provide for the control of electrical loads within a group. In one embodiment, a plurality of electrical loads are connected to an electrical grid and, upon detection of a predetermined condition, a user-defined sub-set of the electrical loads are disconnected from the electrical grid. The predetermined condition may be, for example, a blackout, thus when an interruption in power from the grid is detected by one or more sensors, the user-defined sub-set of the electrical loads is electrically disconnected from its electrical connection to the grid power. Following this disconnection, at least one of the electrical loads from the user-defined sub-set of the electrical loads is connected to an alternative source of power, such as a backup battery, a solar power system, a generator or the like.

### CROSS-REFERENCE TO RELATED APPLICATION

This application is a continuation of U.S. application Ser. No. 17/693,564, filed on Mar. 14, 2022, presently pending, which was a continuation-in-part of U.S. application Ser. No. 17/693,564, filed on Mar. 14, 2022, now abandoned, which claimed the benefit of U.S. Provisional Patent Application No. 63/207,657, filed on Mar. 12, 2021, each of which is hereby incorporated by reference in its entirety.

### BACKGROUND

### 1. Field

The disclosure of the present patent application relates to managing energy consumption and production in a group of electrical loads, and particularly to the prioritized disconnection or shedding and/or reconnection of individual electrical loads to meet pre-defined energy-related preferences and/or goals based on inputs and/or measurements with or without further data processing.

### 2. Description of the Related Art

So-called “smart meters” are well known and are readily available to consumers. A typical smart meter is an electronic device that records basic power information, such as consumption of electric energy, voltage levels, current, and power factor. Typical smart meters communicate the information to the consumer to indicate consumption behavior, as well as duplicating the function of a conventional utility power meter. Although smart meters and similar devices, such as home energy monitors, provide consumers with indications of where energy can be saved, how energy costs can be lowered, etc., the actual implementation of any energy saving plan must be performed manually. In other words, although a smart meter may provide an indication of which electrical devices in a home draw the most power or get the most usage, it is up to the user to manually disconnect the device, or limit its usage, in order to conserve electricity with respect to rate structure or on-site generated power, for example, from installed solar panels or an electric generator powered by other means.

In addition to the manual disconnection by the user described above, smart meters, home energy monitors and the like only provide information directly related to power consumption without any further considerations, such as how that power consumption translates into actual costs. Further, such smart meters and the like are adapted solely to measure power consumption from the conventional utility grid and are not easily integrated into systems which include an alternative power supply, such as, for example, solar panels or wind turbines.

Further, in addition to the above, it is noted that battery storage systems are becoming increasingly popular for homes and businesses. Such systems provide numerous benefits, such as providing backup power during a blackout, time shifting energy use, implementation of energy arbitrage, and providing demand charge management. However, the energy storage of a battery backup system is, by necessity, limited by the capacity of the battery, and the power output of a battery backup system is limited by the discharge rate of the battery and the capacity of the accompanying inverter.

When operating, a number of home appliances draw substantial amounts of power when both starting and during operation. For example, a refrigerator, clothes dryer, electric vehicle charger, air conditioner, pool pump and electric oven may all be operating at once. In the event of a sudden switch to battery backup power, the battery and/or inverter may not be able to meet the full load requirements suddenly placed on the backup system. Further, it is impossible predict when a blackout may occur, thus it is quite possible that a blackout could occur when the backup battery is only partially charged, putting even further strain on the backup system.

The above limitations are the result of present backup systems being unequal in terms of power and capacity to the electrical grid. Although battery backup systems are designed to backup power for an entire building, the limitations on the battery necessarily mean that such power can only be provided for an entire building for a very short period and/or that certain appliances (particularly those which require a high startup current) simply cannot be properly powered. In such situations, the user is typically required to manually disconnect these appliances.

As a result of the above, typical battery backup systems are configured to provide power only to essential loads (e.g., lights, refrigerators, televisions, computers, small appliances, etc.) during a blackout. The wiring to power only these critical loads can be complicated, adding to the expense of battery backup systems. Further, some customers may want to operate larger appliances for a short amount of time; e.g., to partially charge an electric vehicle. Since it is impossible to predict when a blackout may occur, it is not practical to expect a customer to always be able to manually disconnect particular appliances during a blackout. Automatic control of both essential and non-essential appliances would be of great benefit to users during blackouts and similar situations. Thus, an energy management system and method solving the aforementioned problems are desired.

### SUMMARY

The energy management system and method provide for the control of electrical loads within a group and/or overall energy consumption based on pre-defined energy-related preferences and/or goals, which may be based on inputs and/or measurements, with or without further data processing, and may further be adaptive. The electrical loads in the group of electrical loads are prioritized in terms of importance, criticality, or user-defined goals to remain electrically connected. Prioritization can be received as rankings input by the user or as a set of rankings generated by a learning-based artificial intelligence system, providing an adaptive architecture for defining goals and/or rankings. One or more energy-related preferences and/or goals are received, with the one or more energy-related preferences and/or goals including at least one energy-related parameter. The one or more energy-related preferences and/or goals may be received as input from the user through a user interface, using, for example, a sliding controller displayed to the user on the user interface. Energy consumption, as well as any other desired energy line characteristics, of each of the electrical loads in the group is monitored, and at least one lowest ranked electrical load is disconnected when the monitored energy consumption (or other energy line characteristics) deviates from the one or more energy-related preferences and/or goals, and such load shedding may continue until the energy-related preference and/or goals are achieved, or all available loads have been shed. Similarly, once the condition(s) that caused the load shedding has/have abated, or any other combination of specified conditions occur, the shed loads may be reconnected and re-energized to restore their operation. Such disconnection and reconnection may occur in a manner that is cascaded or timed to protect the energy system and attached loads to prevent over-cycling or other undesirable energy system and load conditions.

With regard to the artificial intelligence learning-based embodiment, rather than basing disconnection or shedding on real time monitoring, or in addition to real time monitoring, the disconnection or shedding of electrical loads may be based on learned behavior, including, but not limited to, a predicted load distribution or balance, load output based on environmental factors, such as weather or irradiation, in view of historical data for these parameters, time of the day, day of the year, month or season, predicted rolling blackouts based on these or other factors, market dependence, market energy prices, market energy rates, and the like.

Non-limiting examples of energy-related parameters that may be used herein include, but are not limited to, time of use-related expenses, energy demand-related expenses, overall average energy expenses, and combinations thereof. Additionally, the group of electrical loads may be connected to an alternative source of energy, such as a generator, a solar power system, an energy storage device, such as a storage battery, or the like. Thus, the at least one energy-related parameter may be expanded to incorporate parameters related to the connected alternative source of energy. Non-limiting examples of such parameters related to the connected alternative source of energy include average energy exported to an electrical grid from the alternative source of energy, average battery charge time, battery charge level, average battery discharge rate, peak battery discharge rate, battery life, generator run time, remaining fuel level, peak energy, average available energy, and combinations thereof. Additionally, the system may be used to manage the group of electrical loads and the at least one alternative source of energy to prevent an overload state in the at least one alternative source of energy. The system may also be used to control an amount of energy exported from the alternative source of energy to the electrical grid.

When at least one energy storage device, such as a battery or the like, is also connected to the group of electrical loads, the system may periodically charge the energy storage device for routine charging thereof and/or to determine one or more performance-related parameters of the energy storage device.

Additionally, at least one external parameter may be monitored for adjusting at least one operational parameter of at least one of the electrical loads based on the at least one external parameter. As a non-limiting example, one or more sensors may be provided for measuring the ambient temperature, and control over a set point for an air conditioner, heating system, water heater or the like may be controlled based on the measured temperature, thus reducing the load without necessarily disconnecting the load.

In an alternative embodiment, a plurality of loads connected to both the electrical grid and an alternative source of power can be managed. Upon detection of a predetermined condition (e.g., a blackout, a brownout, an environmental condition, etc.), a user-defined sub-set of the electrical loads may be disconnected from the electrical grid. It should be understood that the sub-set of the electrical loads may include anywhere between one selected load and all of the loads. Additionally, in response to the detection of the predetermined condition, at least one of the electrical loads from the user-defined sub-set of the electrical loads may be connected to an alternative source of power (e.g., solar power, wind power, battery backup power, etc.). It should be understood that the number of electrical loads from the sub-set which are reconnected to the alternative source of power is user-selected and may be anywhere between a single one of the loads contained in the sub-set and all of the loads contained in the sub-set. When the predetermined condition is no longer detected, one or more of the electrical loads from the user-defined sub-set of the electrical loads is disconnected from the alternative source of power and the user-defined sub-set of the electrical loads is reconnected to the electrical grid.

In this embodiment, it should be understood that the predetermined condition may be any suitable condition selected for the purpose of disconnecting the loads from the grid. As non-limiting examples, the predetermined condition may be a detected change in line voltage from the electrical grid, or a detected change in current from the electrical grid. Additionally, through the usage of an interface, an indication of the state of operation of each of the electrical loads may be provided to the user. The interface may be a wireless interface for transmitting a signal representative of the state of operation of each of the electrical loads to the user or the user's wireless device.

Further, disconnection from the electrical grid and reconnection to the alternate source of power may each be performed with a user-defined time delay and/or according to a user-defined sequence. Disconnection and reconnection at any step may be performed by any suitable type of electrical contactor, electrical relay, switch, switching circuit or the like, which may be under the control of any suitable type of controller, such as an analog controller, with or without a digital control board, an automatic transfer switch, a manual transfer switch or the like, or combinations thereof.

These and other features of the present subject matter will become readily apparent upon further review of the following specification.

### BRIEF DESCRIPTION OF THE DRAWINGS

FIG. 1 is a block diagram showing system components of an energy management system.

FIG. 2 is a block diagram showing components of a control system of the energy management system.

FIG. 3, FIG. 4, FIG. 5, FIG. 6, FIG. 7, FIG. 8, FIG. 9, FIG. 10 and FIG. 11 are screenshots of a user interface of the energy management system.

FIG. 12 is a block diagram showing system components of an alternative embodiment of the energy management system.

FIG. 13 is a block diagram showing system components of another alternative embodiment of the energy management system.

FIG. 14 is a block diagram showing system components of another alternative embodiment of the energy management system.

FIG. 15 is a block diagram showing system components of another alternative embodiment of the energy management system.

FIG. 16 is a block diagram showing system components of another alternative embodiment of the energy management system.

Similar reference characters denote corresponding features consistently throughout the attached drawings.

### DETAILED DESCRIPTION OF THE PREFERRED EMBODIMENTS

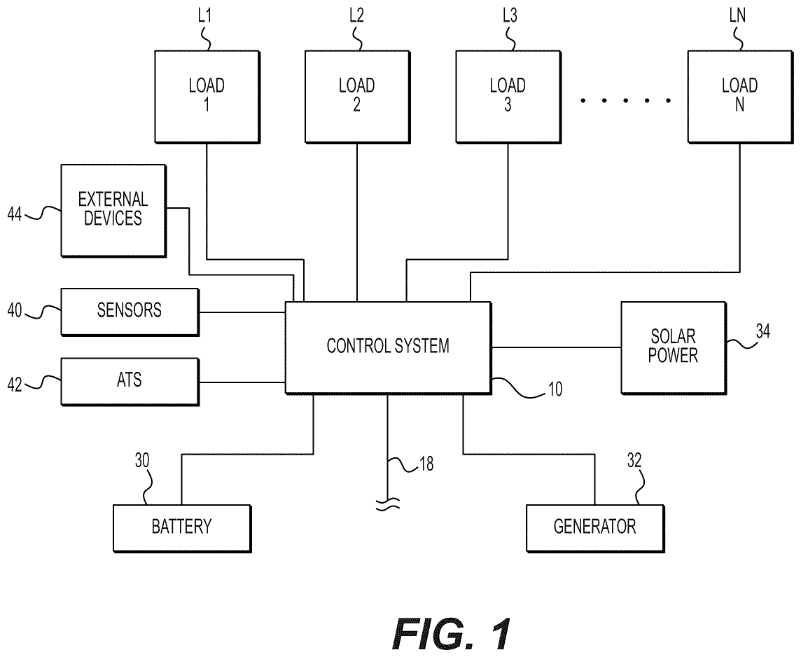

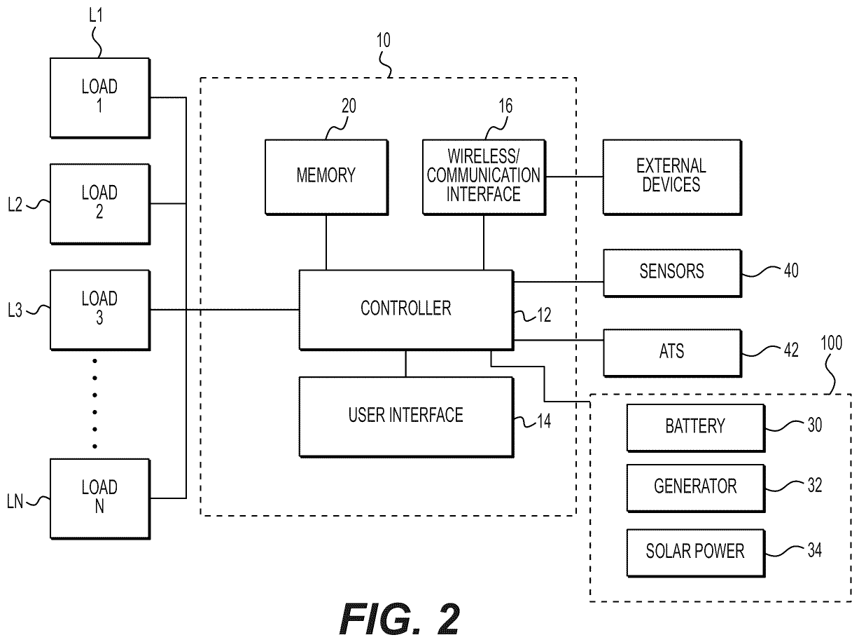

As shown in FIGS. 1 and 2, the energy management system includes a control system 10 adapted for connection with N electrical loads L1, L2, L3, . . . , LN, where it should be understood that N represents an arbitrary number of electrical loads within a particular group. As will be discussed in greater detail below, in addition to conventional electrical loads L1, L2, L3, . . . , LN, loads constituting, or at least partially including, one or more supply grids are also contemplated, such as, but not limited to, storage batteries, inverters, etc. As a non-limiting example, the N electrical loads L1, L2, L3, . . . , LN may include any critical and/or non-critical electrical appliances and devices powered by the electrical grid within a household or small commercial business. In FIG. 1, line 18 represents a connection to the electrical grid, although it should be understood that control system 10 may be interconnected between loads L1, L2, L3, . . . , LN and any suitable source of electrical power.

It should be understood that additional sources of power and/or storage may also be connected to the electrical grid ultimately through line 18, such as, for example, a storage battery 30, a generator 32, and a solar power system 34, as illustrated in the non-limiting example of FIG. 1. It should be further understood that the N electrical loads L1, L2, L3, . . . , LN are not limited to any particular type of electrical loads, and may be any type of electrical load. Non-limiting examples of such loads include electric vehicles, HVAC systems, stoves, water heaters and the like.

As shown in FIG. 2, control system 10 includes at least one controller 12, which operates on software, programming, or the like to provide monitoring and management of the attached energy loads L1, L2, L3, . . . , LN based on pre-configured and periodically captured information inputs to achieve the user's desired energy consumption and system goals. As will be discussed in greater detail below, programmable data, input parameters and the like may be entered through any suitable type of user interface 14, and may be stored in memory 20, which may be any suitable type of computer readable and programmable memory and is preferably a non-transitory, computer readable storage medium. Calculations and program operations are performed by controller 12, which may be any suitable type of computer processor and may be displayed to the user via user interface 14 or a separate display. As a non-limiting example, user interface 14 may be a touchscreen or the like. A wireless interface 16 may also be provided for wireless communication with remote systems or remote controllers. Although FIG. 2 illustrates a simplified direct feed from each load L1, L2, L3, . . . , LN into controller 12, it should be understood that this is for purposes of illustration only, and that any suitable type of interfaces, circuitry, buses, meters, monitors or the like may be provided for controller 12 to monitor and control the power consumption of each load L1, L2, L3, . . . , LN.

It should be understood that communication between controller 12 and each electrical load L1, L2, L3, . . . , LN, as well as additional sources of power and/or storage, such as, for example, storage battery 30, generator 32, and solar power system 34, as well as any other devices desired to connect with controller 12, may be implemented using any suitable type of communication, such as, for example, the integrated communication systems and protocols found in commercially available Internet-of-Things (IOT) devices, devices adapted for communication with cloud-based storage and control, and devices adapted for communication with app-based control, as well as conventional wireless and wired communication protocols, such as Wi-Fi, Bluetooth®, ethernet, Zigbee®, RS-232, RS-485, cellular communication and the like.

In FIGS. 1 and 2, control system 10 is shown in communication with one or more external devices 44 through communication interface 16. It should be understood that controller 12 may communicate with, receive data from, send data to, and/or control any suitable type of external device adapted for communication. Non-limiting examples of such external devices 44 include virtual assistant devices, security systems, thermostats and IOT devices. Further, controller 12 may also issue control signals indirectly through, or receive data indirectly from, a secondary control/data device. As a non-limiting example, external devices 44 may include a home virtual assistant which is itself already integrated into a home network of electrical appliances and devices. In this example, the home virtual assistant may already control home appliances such as lights, fans, etc., and may also already receive data from smart appliances which measure things like temperature, power consumption, etc. Controller 12 may control operation of these external devices 44, and also receive data therefrom, through the home virtual assistant.

It should be understood that controller 12 may incorporate, or be connected to, any suitable type of monitors or meters, such as, but not limited to, meters adapted for monitoring electrical current, voltage (L1, L2, L3), phase angle/power factor, frequency and waveform. The monitors or meters may include, or be integrated with, the current transformers of solar power system 34, battery 30, the individual electrical loads, etc. Further, as will be discussed in greater detail below, controller 12 may disconnect or shed individual loads, or limit power thereto, thus it should be understood that controller 12 may incorporate, or be connected to, any suitable devices for performing disconnection or power control. Non-limiting examples of such devices include current-limited contactors, current-controllable inverters, current-controllable energy modules (and/or modules affixed with current-limited and/or controllable output), and the like, allowing for the control of one or more electrical loads by modulating or interrupting electrical current between the loads and their respective protective breakers.

Controller 12 may be associated with, or incorporated into, any suitable type of computing device, for example, a personal computer or a programmable logic controller. The user interface 14, the controller 12, the wireless interface 16, the memory 20 and any associated computer readable recording media are in communication with one another by any suitable type of data bus, as is well known in the art. Examples of computer-readable recording media include non-transitory storage media, a magnetic recording apparatus, an optical disk, a magneto-optical disk, a memory card, an SD card, and/or a semiconductor memory (for example, RAM, ROM, etc.). Examples of magnetic recording apparatus that may be used in addition to memory 20, or in place of memory 20, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, with the sole exception being a transitory, propagating signal.

Through user interface 14, the user may assign load priority to each load L1, L2, L3, . . . , LN, or to a group of the loads. As an alternative to the manual input of such load priority, controller 12 may run artificially intelligent software which monitors, over time, the user's preferences, the actual on-off state of each load, and energy use behavior and patterns and, using this monitoring data, which is received over time, learns which loads are used and/or prioritized most, thus automatically developing a priority ranking for the loads. This automatically developed priority ranking would then be input to assign load priority to each load L1, L2, L3, . . . , LN, or to a group of the loads. Thus, either through manual input or through input by artificial intelligent learning (or a hybrid of both), individual loads or groups of loads can be assigned a priority ranking. It should be understood that any suitable type of learning-based artificial intelligence system may be used to monitor a user's manual input over a period of time and/or to monitor the user's preferences, the actual on-off state of each load, and energy use behavior and patterns in order to generate the prioritized ranking.

As a non-limiting example, a maximum energy state or condition can be defined when all loads L1, L2, L3, . . . , LN are connected and able to consume electrical power. A first reduced energy state or condition can then be achieved by controller 12 disconnecting power to the lowest ranked load (or group of loads). A second reduced energy state or condition can be achieved by controller 12 disconnecting power to the next lowest ranked load (or group of loads), etc. This can be followed all the way to a minimum energy state or condition, where all loads (except any loads with a critical “always on” rating) are disconnected.

As a non-limiting example, considering a typical household with a wide variety of electrical loads, typical “always on” electrical loads (e.g., any or all of refrigerators, freezers, alarm systems, lighting, etc.) may remain connected to the electrical grid in the typical manner (i.e., using conventional circuits, circuit control system, circuit breakers, etc.). A selected group of electrical loads, however, may be controllable using the present system, with this selected group of non-critical loads having their electrical connections intercepted by control system 10 just behind the corresponding circuit control system(s) and before the particular load. By way of non-limiting example, if the circuit control system is a circuit breaker, this may be implemented right in the circuit breaker box (or a specialized circuit breaker box which incorporates an integrated control system 10). Any suitable type of contactors, circuits, interfaces, etc. may be used to connect control system 10 between the load(s) and the external power supply (i.e., connection to the grid through line 18). It should be understood that in the above non-limiting example, typical examples of household or residential loads are provided, although control system 10, and each of the following embodiments, may be used with any type of electrical load, including, but not limited to, those discussed above, as well as typical loads found in commercial buildings, public structures and the like.

As another non-limiting example, sensors, smart meters, or the like may be connected to the loads L1, L2, L3, . . . , LN to measure the respective operational currents (in real time) of the loads. The controller 12 is either in communication with the sensors, smart meters or the like, or incorporates them as part of an integrated control unit. When the measured current(s) exceed the predetermined goal (which may be based on a number of different factors), controller 12 generates signals which control current interrupters or the like to disrupt the lowest ranked one(s) of the loads L1, L2, L3, . . . , LN. Controller 12 is programmed to activate the current interrupters or the like to shed the loads in a predetermined sequence based on the prioritized ranking. After shedding sufficient loads to reduce the overall current to a point equal to or less than the predetermined peak total current (based on the particular goal(s) of the user), controller 12 then determines whether any of the loads which have been shed can be restored to operation without exceeding or deviating from the set goal(s). If so, that load is automatically restored to operational status.

It should be understood that any suitable type of circuit interrupter, circuit breaker, transformer, inverter or the like may be used to temporarily shed, or limit power to, the lowest ranked load(s). Similarly, it should be understood that controller 12 may communicate with these devices using any suitable type of interfaces, buses, switches, communication lines, etc. Controller 12 is adapted to transmit any suitable type of control signal to the circuit interrupter or the like, or to any associated circuits or devices associated therewith, to initiate the temporary shedding or power limiting thereof. Further, in addition to shedding or limiting power, it should be understood that any suitable type of circuit, device or the like may also be used to increase power to one or more loads from an alternate power source, such as battery 30; e.g., battery 30 may be used as part of an energy arbitrage strategy, with controller 12 increasing output of battery 30 to one or more loads in order to reduce the cost of energy obtained from the electrical grid.

In addition to full disconnection, it should be understood that controller 12 may also be used to change or augment the settings on particular ones of the electrical loads L1, L2, L3, . . . , LN. As a non-limiting example, one or more sensors 40 may be connected to control system 10, and the one or more sensors 40 may include a temperature sensor, such as a thermostat, thermocouple or the like. Controller 12 of control system 10 may be used to automatically change the set point on a temperature-dependent load in this example, such as a heating system, cooling system, water heater, etc. Thus, the user-defined or artificial intelligence-defined goals may be achieved through feedback from the one or more sensors 40, and do not necessarily have to involve a complete disconnection of loads. It should be understood that the one or more sensors 40 may be any suitable type of sensors and may measure any desired parameters. Non-limiting examples include temperature, solar-related parameters for solar power system 34 (e.g., light intensity, wavelength distribution, cloud coverage, etc.), atmospheric pressure, humidity, dew point, etc.

With regard to the artificial intelligence learning-based embodiment, rather than basing disconnection or shedding on real time monitoring, or in addition to real time monitoring, the disconnection or shedding of electrical loads L1, L2, L3, . . . , LN may be based on learned behavior, including, but not limited to, a predicted load distribution or balance, load output based on environmental factors, such as weather or irradiation, in view of historical data for these parameters, time of the day, day of the year, month or season, predicted rolling blackouts based on these or other factors, market dependence, market energy prices, market energy rates, and the like.

Through user interface 14, the user may program controller 12 to consider a wide variety of user goals and scenarios. As a non-limiting example, the user may wish to reduce time of use (TOU) related expenses. When selecting this goal, controller 12 may perform the necessary calculation to disconnect or connect loads according to the prioritized ranking discussed above in order to achieve the input desired average energy rate. Returning to FIG. 1, alternate sources of power may be considered, such as one or more connected batteries 30, one or more generators 32, one or more solar panels 34, or the like, or any combination thereof. Controller 12 may be programmed to consider all available sources of power and, in order to meet the input desired average energy rate, controller 12 also has the option of taking part or all of the system “off grid” (i.e., disconnecting from the electrical grid) to operate from one or more of the local power sources 30, 32, 34 for a desired period of time. Controller 12 may control the balance of power drawn from the grid in view of the power drawn from the alternative local power sources 30, 32, 34 (i.e., operate in a balanced or controlled hybrid configuration) and/or may control how much power is returned to the grid (i.e., control energy exported from the local power sources back to the grid).

As further non-limiting examples, controller 12 may perform the necessary calculations to disconnect loads according to the prioritized ranking discussed above, or to go off grid, in order to achieve an input desired demand charge reduction, or an input desired average energy savings. As a further non-limiting example, in the case where solar power system 34 and/or a generator 32 is producing excess power, controller 12 may perform the necessary calculations to go on and off grid based on an input desired average energy export value. As an additional non-limiting example, where the system includes at least one battery 30, controller 12 may perform the necessary calculations to disconnect loads according to the prioritized ranking discussed above in order to attempt to achieve an input desired average battery charge time, which is typically subject to a maximum allowable charge rate while not exceeding the user's desired grid power consumption. The battery charge can be achieved using energy received from the energy grid, the solar power system 34, the generator 32, or any combination thereof.

As noted above, the system may limit, set or restrict the export or back-feeding of energy to the electrical grid, thus allowing a safe means of installing more solar capacity than would typically be allowed by the interconnected utility grid. Typically, only 20% of the system main breaker is allowed to be exported or back-fed, however, by limiting the back-feed current in a controlled and programmable manner, this 20% restriction to the utility grid can be met while allowing a much higher actual number of installed solar panels without an additional risk to the utility grid, thus providing a benefit to homeowners and small businesses, for example, who may wish to install more solar panels to meet more of their energy needs using solar power.

Similarly, controller 12 may be programmed to operate in a fully off grid mode. Thus, as a non-limiting example, controller 12 may perform the necessary calculations to disconnect loads according to the prioritized ranking discussed above in order to achieve an input desired battery life. The user may input, or the controller 12 may otherwise collect, data regarding the battery charge state and size, the maximum battery discharge rate, etc. in order to properly calculate the load requirements for battery usage and/or charging. Similarly, as another non-limiting example, controller 12 may perform the necessary calculations to disconnect loads according to the prioritized ranking discussed above in order to achieve an input desired generator run time. The user may input, or the controller 12 may otherwise collect, calculate and/or predict, data regarding the generator fill level, generator size, maximum generator kW rating, etc. in order to properly calculate the load requirements for generator operation. As discussed above, one or more sensors 40 may be employed to, for example, monitor generator parameters. These parameters may also be manually input or learned by the artificial intelligence system.

As a further off grid non-limiting example, controller 12 may perform the necessary calculations to connect or disconnect loads according to the prioritized ranking discussed above in order to achieve a desired input average maximum available energy, subject to battery, solar and generator hard limits, e.g., battery discharge rate, generator maximum kW rating, etc. As an additional non-limiting example, if solar production exceeds energy consumption within the system, controller 12 may perform the necessary calculations to disconnect loads according to the prioritized ranking discussed above in order to achieve the desired input battery charge time. It should be understood that in off grid mode (or a hybrid mode), controller 12 also performs the same functions as in on grid mode; i.e., regardless of the power source for the electrical loads L1, L2, L3, . . . , LN, controller 12 may connect or disconnect loads according to their prioritized ranking in order to reduce or increase energy based on the energy-related preferences and/or goals. However, regardless of whether system is on grid, off grid or in a hybrid mode, controller 12 may further disconnect the alternative energy sources and/or energy storage systems.

As a non-limiting example, controller 12 may disconnect battery 30 from the electrical loads in order to allow it to charge from a selected power source (e.g., solar power system 34, generator 32, or the electrical grid). Controller 12 may control which loads are served by a particular power source; e.g., battery 30 could be charged by generator 32 while selected ones (or all) of the electrical loads are powered by the electrical grid. As a non-limiting example, controller 12 could implement A×B full matrix switching where any number of energy sources A could be matrixed to any number of loads B in any singular or plural fashion (i.e., a so-called “full” matrix capability).

The above examples allow the energy management system to act as a microgrid and/or virtual power plant (VPP). Additionally, this allows the system to be (optionally) started without externally supplied power (i.e., a “black start”), as well as providing further capability to respond to inputs from third-party microgrids and/or grids and/or VPPs. Additionally, controller 12 may act to control energy exported from the microgrid and/or VPP back to the electrical grid, including, but not limited to, adding electrical loads to limit how much power is exported. Controller 12 may also be used, as non-limiting examples, to manage voltage and coordinate loads and energy production across the microgrid and/or VPP and the connection to the electrical grid, implementing Active Grid Management (AGM). In the non-limiting example of FIG. 2, battery 30, generator 32 and solar power system 34 are shown making up a microgrid or VPP 100, which is under the control of control system 10.

The establishment of a microgrid and/or VPP, either alone or in combination with another connected microgrid and/or VPP, may also be used, as non-limiting examples, to lift a sagging electrical grid, prepare/balance backup storage power, dynamically balance generation and consumption by the electrical loads, and provide for the quantification, tracking, reporting, selling, trading and buying of energy units via tokens, currency, other securities or the like.

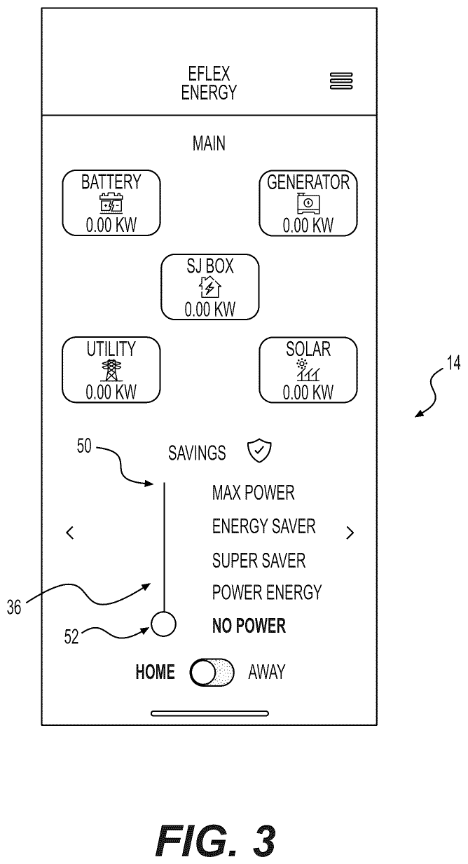

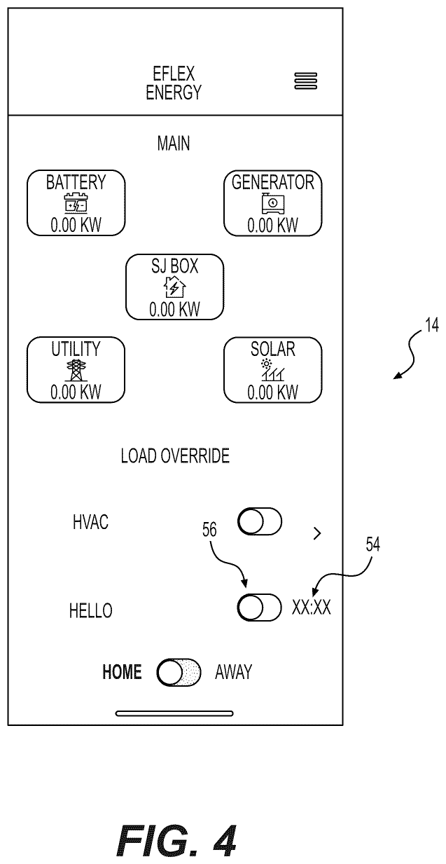

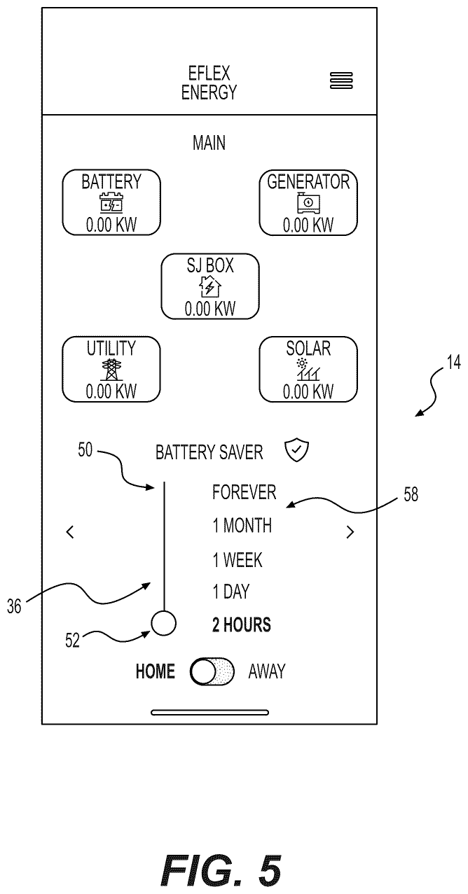

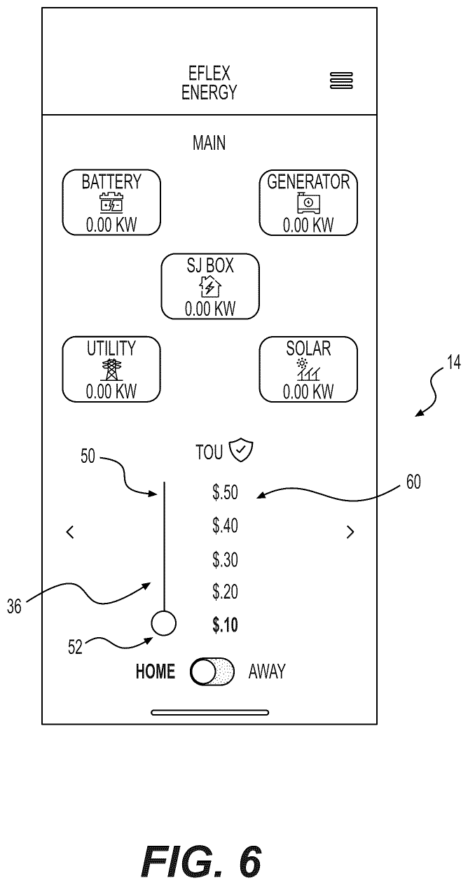

FIG. 3 shows an exemplary screenshot of an operating display of user interface 14, which may be a touchscreen or the like. As shown, the assignment of a load priority for each load or load group or the operating mode may be selected through a “slider” control 36 displayed to the user. This visual controller 36 may be operated manually or automatically by the software application, and in both cases will update and show the current operating mode or status. It should be understood that the displays of FIGS. 3-11 are shown for exemplary purposes only. In the example of FIG. 3, a “high” energy setting is indicated generally as 50 and a “low” energy setting is indicated generally as 52. Thus, the user may slide the sliding control 36 upward to increase desired energy use, and slide the sliding control 36 downward to decrease desired energy use. In the “low” energy configuration shown in FIG. 3, only critical loads are connected. It should be understood that any suitable type of controls and/or user interface may be used, and that displays of FIGS. 3-11 are shown for exemplary purposes only. As a non-limiting example, rather than a touchscreen display, the controls could be purely analog controls, or analog controls combined with digital controls, including, but not limited to, analog switches, knobs, variable resistors and the like.

In addition to the exemplary control goals and modes discussed above, the user may also enter a wide variety of other parameters for controller 12 to consider in its calculations and operations. As non-limiting examples, such parameters may include time, system state (e.g., attached to an active electrical utility grid, attached to an active solar system or battery system, not attached to an active electrical utility grid, etc.), occupancy state (e.g., “home” or “away”), local current or predicted weather conditions, local or predicted utility conditions, instructions received from a utility or other third party, etc. As a further non-limiting example, controller 12 may be programmed to prevent overloading of an attached energy source (e.g., solar power system 34, battery 30, etc.) by limiting maximum energy demand within a response time frame to provide such protection effectively, wherever possible. Similarly, as another non-limiting example, controller 12 may be programmed to manage the connected loads to prevent discharging attached energy storage (e.g., battery 30) too rapidly, which may cause damage or reduce storage component life. Thus, controller 12 may act as a battery asset manager to reduce battery degradation. Further, when implementing the artificial intelligence system, battery asset management may be at least partially based on learned historical data.

As discussed above, controller 12 may include, or may be separately connected to, any suitable type of meters or monitors for providing real-time energy information associated with the loads and any additional connected sources of power. It should be understood that communication with such meters or monitors may be implemented using any suitable type of communication system or protocol, such as the on-board communication equipment installed in conventional Internet-of-Things (IOT) devices, Wi-Fi wireless communication, the RS-485 communication standard, application programming interfaces (APIs), etc.

Additionally, although the simplified diagram of FIG. 2 illustrates only a single controller 12, it should be understood that a controller 12 may operate on its own, or may operate in conjunction with any suitable number of “slave” devices or circuits in communication with controller 12. It should be understood that any suitable configuration or architecture for such slave devices may be used, such as a hive, an ad hoc network, a coordinated network or the like. Additional hardware arrangements will be discussed in greater detail below. Further, as discussed above, controller 12 may be in communication with a wireless interface 16, allowing for remote control and programming of controller 12. It should be understood that wireless interface 16 may be replaced by, or used in conjunction with, wired communication. It should be further understood that controller 12 is not required to operate locally with respect to loads L1, L2, L3, . . . , LN. Controller 12 may be remote with respect to loads L1, L2, L3, . . . , LN, or may be used in conjunction with a control-level server or system which is located remotely, such as, for example, the control-level servers or systems which are used to coordinate conventional Internet-of-Things (IOT) devices.

FIGS. 4-11 show a variety of further exemplary screenshots. As noted above, the displays illustrated in FIGS. 3-11 are shown for exemplary purposes only. The non-limiting example of FIG. 4 shows exemplary controls allowing the user to override the programmed load prioritization as well as manually set the exemplary geofencing states “home” and “away”. In this exemplary display, the loads included in the display can be selected to be included in the set of loads for prioritization. In the example of FIG. 4, the virtual button 56 indicates whether the override is set to on or off. When the override is on, a time display 54 may be presented to indicate to the user how much time remains until the override is over.

FIG. 5 illustrates the exemplary slider control 36 in the context of a battery life control. In the example of FIG. 5, display portion 58 indicates the runtime of battery 30 when the system is off grid. In such a condition, controller 12 will reduce the load and/or battery demand to meet the slider setting 36 based on instantaneous and predicted loads.

FIG. 6 illustrates the exemplary slider control 36 in the context of a time of use (TOU) control for inputting desired energy usage by cost. In the example of FIG. 6, display portion 60 shows a listing of exemplary TOU rates. Both TOU and tiered rates may have a separate display screen for entry of the particular rate details, such as, for example, cost/kW, the time(s) each rate is active, the kWh amount and cost, the seasonal rate, etc. The user may also choose whether these details are populated/updated by controller 12, by manual input from the user, or from a third-party system. In the configuration of exemplary FIG. 6, controller 12 will reduce loads and optimize energy arbitrage of battery 30 (or other storage devices) to maintain the cost per kWh at or below the setting of slider control 36.

FIG. 7 illustrates the exemplary slider control 36 in the context of input energy demand cost. In the example of FIG. 7, button 64 allows the user to set the “home” or “away” mode manually. Alternatively, this may be set through geofencing of one or more users. Users have a priority mode in the load priority-setting table. Display area 62 shows demand charges, where controller 12 measures the kWh used over a particular demand time (e.g., 15 minutes) and adds or subtracts power as required to maintain a desired rate over this particular demand time. Controller 12 will reduce loads or add power from battery 30, generator 32, solar power system 34, etc. to ensure the demand charge is at or below the setting of slider control 36.

FIG. 8 illustrates an exemplary screen for manually setting priority of individual loads. In exemplary FIG. 8, example display area 66 may display “ON GRID”, “OFF GRID”, “ON GRID AWAY”, or “OFF GRID AWAY”. With regard to display area 68, in this example, when the TOU or tiered rate is selected, the TOU or tiered rate structure will also be the load priority times.

FIG. 9 illustrates an exemplary screen for setting desired display units. FIG. 10 illustrates an exemplary system configuration screen. In exemplary FIG. 10, selection of display/choice area 70 affects what is available for selection in the analog inputs of FIG. 11. As discussed above, the display of FIG. 10 is for exemplary purposes only. As an alternative, for example, the selections illustrated in FIG. 10 could be replaced with drop-down selections. The properties displayed in this screen could further be automatically populated through connection with the particular loads and power sources.

FIG. 11 illustrates an exemplary screen for inputting parameters associated with additional equipment (e.g., solar power system 34, generator 32, etc.). In exemplary FIG. 11, column 72 shows the CT current rating. It should be understood that the values displayed in column 72 are shown for exemplary purposes only. As a non-limiting example, full scale analog voltage is typically 0.33 VAC. If 25 A is selected, the analog voltage is 0.03 VAC RMS, resulting in a current of 2.5 A. In column 74, the displayed channels may only be available if selected in the system configuration. Any spare channels may be named anything by the installer or customer. One or more channels may be reserved to read voltage, typically through an isolation transformer scaled down to ±0.33 VAC or other low voltage. Column 76 shows the current reading, based on the amp rating and voltage. In the example of FIG. 11, column 78 shows the actual analog voltage reading for a debugging configuration.

In addition to the above, controller 12 may communicate with external systems, either through wireless interface 16 or a wired connection, in order to, for example, issue and/or receive commands and data to/from third-party devices, such as inverters, battery management systems, solar module monitors and controllers, electric vehicles and their chargers and smart meters, etc.

Additionally, controller 12 may be programmed to periodically charge attached energy storage (e.g., battery 30) to determine charge capacity, degradation, and other performance parameters to inform the system and third-parties, such as installers, storage suppliers, or storage manufacturers, as to system state and performance. Controller 12 may also periodically charge cycle attached energy storage (e.g., battery 30) to keep the storage exercised, extend or improve storage performance, or to better comply with the manufacturer's suggested operating instructions; i.e., as discussed above, controller 12 may also perform the functions of a battery asset manager. Controller 12 may also receive input regarding ambient temperature and/or other parameters to actively manage the charge point, charge rate, discharge rate, battery voltage, battery temperature and the like of attached energy storage (e.g., battery 30) to avoid unfavorable or dangerous operating modes and/or temperatures for the storage, including actively managing charging and, when needed, discharging of the attached storage. Thus, as a further non-limiting example, controller 12 may integrate, or be connected to, additional sensors, such as sensors 40, which may be used for measuring temperature, voltage, current pressure, environmental data and the like.

It should be understood that the additional sensors 40 may be integrated with controller 12 as part of a main control board, for example, or may be modularly or otherwise connected to controller 12 as separate modules or boards. Additional data may be provided through the data already available to conventional IOT devices, such as, for example, the weather services typically supplied to virtual assistants and the like, and may be further provided by any suitable additional sensors or the like which may be integrated into the system, such as wireless sensors designed for integration into adhoc wireless networks, for example.

Through wireless interface 16, or via an alternative wired interface, multiple users may communicate with controller 12, either individually or in parallel, including third parties, utilities, grid managers and/or operators. Controller 12 may send updates about system states, performance, control, alerts, or other parameters to any or all users, either upon request or at specified intervals. Controller 12 may receive inputs for desired preferences or energy-related goals and/or direct commands from any or all users, including third parties, resulting in the energizing or de-energizing of attached loads to achieve desired energy outcomes, including but not limited to those set through any input communications by third parties and/or any outcomes governed by pre-existing agreements or contracts with between the parties and authorities in charge of, or associated with, controller 12.

Further, it should be understood that the control system 10 may operate under, or participate in, any required or desired private or public interconnection agreements, such as those required to be in compliance with local energy regulation requirements, or to be in compliance with other applicable governing requirements, such as UL 1741, SGIP and/or Rule 21. However, noting that UL 1741, SGIP and Rule 21 are each related to inverters, it should be understood that controller 12 may be connected to and control an automatic transfer switch (ATS) 42 to serve as a load manager for controlling devices and systems which consume power but are not inverters.

It should also be understood that control system 10 is not limited to any particular hardware implementation or location. As a non-limiting example, control system 10 may be attached to a panelboard or other electrical enclosure containing other energy monitoring or management components, either with or without an integrated cover, and/or control system 10 may be field-wired to such an existing panelboard, either with or without an integrated cover. As discussed above with regard to the additional sensors, it should be understood that any additional components, including sensors, communication interfaces, contactors, etc. may be integrated with controller 12 as part of a main control board, for example, or may be modularly or otherwise connected to controller 12 as separate modules or boards.

Additionally, either through wireless interface 16, wired interface, or any other suitable means of communication, controller 12 may communicate with other devices, such as connected Internet-of-Things (IOT) devices, in order to create additional functionality accessible through controller 12 and user interface 14. It should be further understood that the wireless or wired communication allows for communication of other data and information with users and/or third parties. Non-limiting examples of such communications include system and product data not limited to energy usage, attached load performance data, or any other system parameter and/or offers for products and services delivered within or outside of the system based on system data.

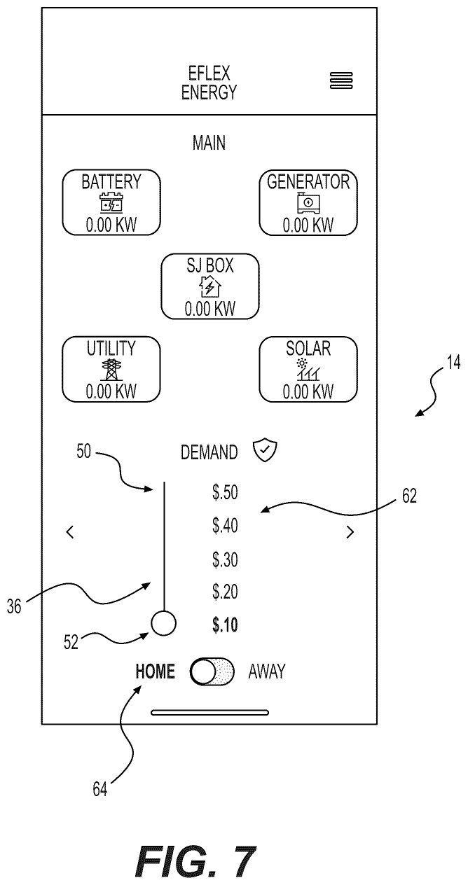

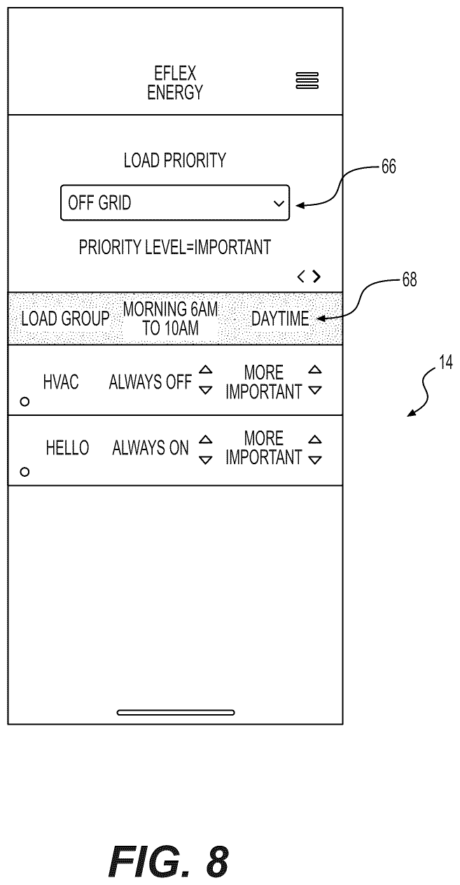

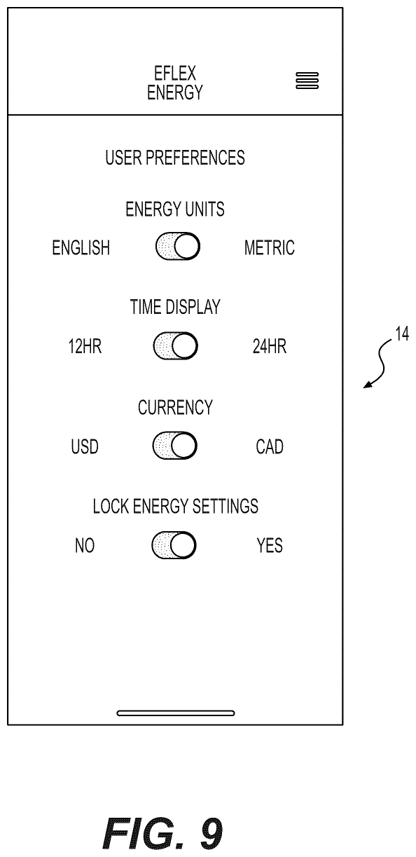

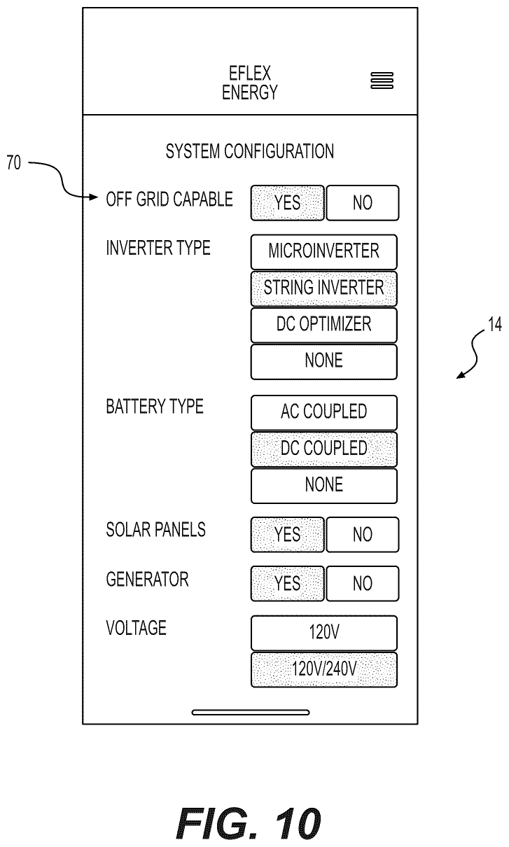

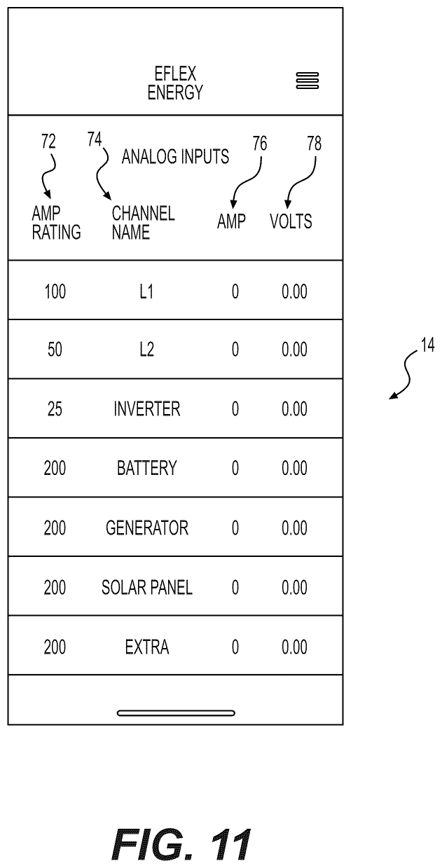

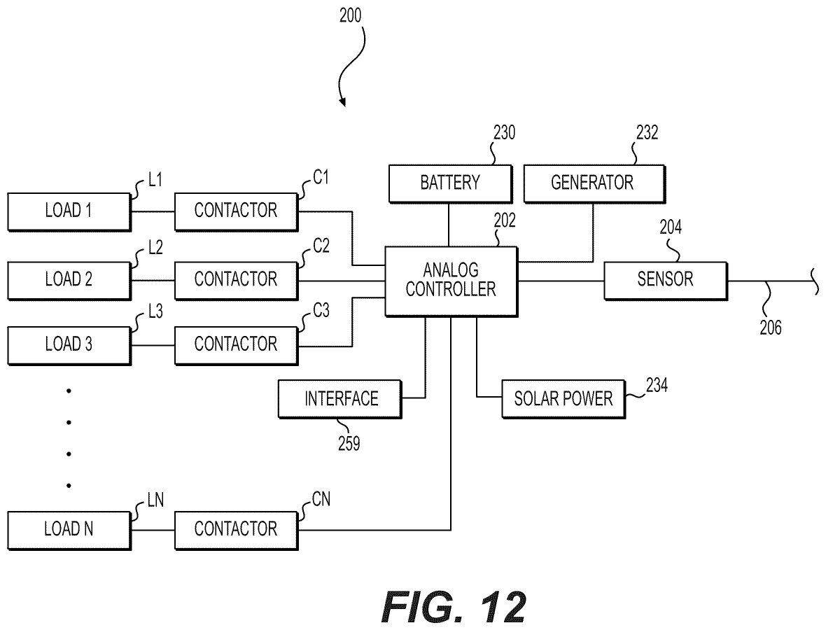

In the alternative embodiment of FIG. 12, an analog control system 200 is shown. Rather than using the control system 10 of the previous embodiment, an analog controller 202 is connected to one or more wires or sensors 204 for monitoring the power coming from the electrical grid 206. It should be understood that wires or sensors 204 may be any suitable type of line meters, monitors or the like for detecting a change in power conditions. Analog controller 202 is set by the user through analog controls, such as switches, knobs, sliders or the like, to disconnect certain ones of loads L1, L2, L3, . . . , LN when sensors 204 detect a pre-set condition (e.g., a brownout, a blackout, a particular power or environmental condition, etc.). During such conditions, one or more alternative sources of power can supply power to desired ones of loads L1, L2, L3, . . . , LN, and non-essential and/or non-desired ones of the loads can be disconnected to save power from the alternative source of power. In the non-limiting example of FIG. 12, the alternative sources of power are shown including a backup or storage battery 230, a generator 232 and a solar power system 234, similar to the storage battery 30, generator 32 and solar power system 34 of the previous embodiment, however, it should be understood that any suitable type of alternative source(s) of power may be connected, such as a wind turbine, a microgrid, a virtual power plant or the like.

In FIG. 12, individual contactors C1, C2, C3, . . . , CN are shown respectively connected to loads L1, L2, L3, . . . , LN for the disconnection or shedding of selected ones of the loads, although it should be understood that any suitable type of contactor, switch, circuit or the like may be used to temporarily disconnect or shed a load. It should be understood that analog controller 202 may be any suitable type of circuit, circuitry, circuit module or the like for actuating contactors C1, C2, C3, . . . , CN or the like upon detection of a pre-set condition from sensors 204, including a wire supplying line voltage directly to a contactor or to a control or controls that then operate the contactor or disconnect switching devices based on the detected line voltage. Further, it should be understood that analog controller 202 may incorporate the circuitry for automatically switching to alternative power from the alternative sources of power 230, 232 and/or 234 upon detection of the pre-set condition from sensors 204.

It should be understood that the block diagram of FIG. 12 is simplified for purposes of illustration. In practice, the power supplied to the loads L1, L2, L3, . . . , LN passes through the analog controller 202 (or through adjacent operated switches or the like) via any suitable type of power lines, with or without additional circuitry, interfaces or the like. It should be understood that the power supplied to analog controller 202 may be supplied via line 206 from the grid, through a line separate from, or in addition to, line 206, from one or more of the alternative sources of power 230, 232, 234, or from any other suitable source of power. In operation, in a manner similar to the previous embodiment, based on the monitoring of sensors 204, analog controller 202 operates contactors C1, C2, C3, . . . , CN (or any other suitable type of switches or the like) to disconnect or reconnect any incoming power (e.g., from the grid through line 206 or from the alternative source(s) of power) and also disconnect or reconnect any of the managed loads L1, L2, L3, . . . , LN. It should be understood that sensors 204 are not limited to only monitoring the power coming through line 206, but may also monitor any desired external parameters or any additional sources of power.

As a non-limiting example of the above, sensors 204 may measure an increase in power generated by solar power system 234 (indicative of the rising of the sun, in this example), and analog controller 202 could be set to close the contactor associated with a pool pump (not illustrated as a specific one of loads L1, . . . , LN in FIG. 12) upon such a detection. Thus, under this pre-set condition, the pool pump is set to run based on the user's knowledge that it will be running on solar power. The analog controller 202 could also be set to switch off the power coming from the electrical grid, via line 206, based on this same condition, ensuring that the pool pump, under this particular condition, will run purely on solar power from solar power system 234.

In a continuation of the above non-limiting example, if measured voltage from the solar power system 234 drops below a pre-set threshold (indicating the sun going down), analog controller 202 could be set to reconnect to the electrical grid based on this measured condition, providing power from the electrical grid, via line 206, to power the pool pump. When the measured voltage from the solar power system 234 goes below this threshold or a secondary threshold, analog controller 202 can be set to disconnect the solar power system 234 for the safety of the attached loads. It should be understood that analog controller 202 does not necessarily fully disconnect from the electrical grid; i.e., controller 202 may operate to switch power from a selected power source for individual ones of the loads. Thus, in the above example, although the pool pump is disconnected from the electrical grid, other appliances and loads do not have to be.

Thus, in general, in the embodiment of FIG. 12, analog controller 202 provides for the management of the plurality of loads L1, L2, L3, . . . , LN connected to both the electrical grid (via line 206) and alternative sources of power. Upon detection of a predetermined condition (e.g., a blackout, a brownout, an environmental condition, etc.) via one or more sensors 204, a user-defined sub-set of the electrical loads L1, L2, L3, . . . , LN may be disconnected from the electrical grid. It should be understood that the sub-set of the electrical loads L1, L2, L3, . . . , LN may include anywhere between one selected load and all of the loads. Additionally, in response to the detection of the predetermined condition by sensors 204, at least one of the electrical loads from the user-defined sub-set of the electrical loads may be connected to an alternative source of power, which is not limited to only the backup or storage battery 230, generator 232 and solar power system 234 illustrated in the non-limiting example of FIG. 12. It should be understood that the number of electrical loads from the sub-set which are reconnected to the alternative source of power is user-selected and may be anywhere between a single one of the loads contained in the sub-set and all of the loads contained in the sub-set.

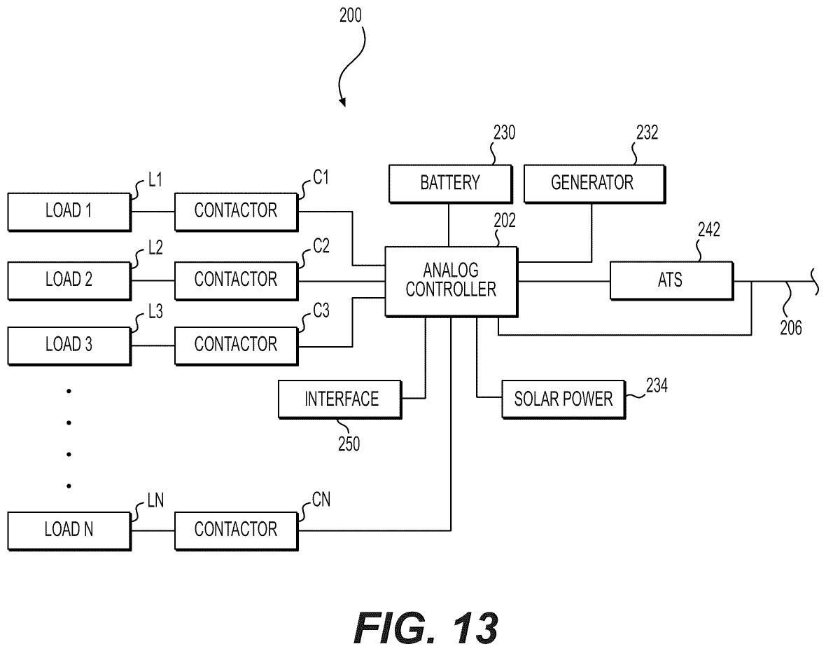

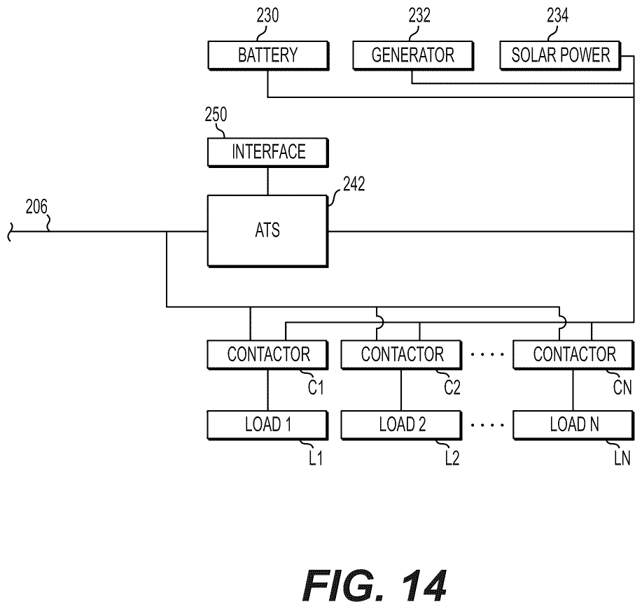

In the alternative configuration of FIG. 13, analog controller 202 is shown connected to, and provides control for, an automatic transfer switch (ATS) 242 to serve as a load manager for controlling devices and systems which consume power but are not inverters. It should be understood that ATS 242 may alternatively be integrated into analog controller 202 or may serve as the analog controller 202 (i.e., the analog controller may be provided in the form of an ATS). FIG. 14 illustrates a configuration where ATS 242 serves as the controller. As shown, in this configuration, the power provided by line 206 to drive the contactors is provided on the other side of ATS 242 than in the configuration of FIG. 12. As in the embodiments of FIGS. 12 and 13, if the grid voltage goes down, for example, the solenoid valve, for example, of each contactor will be depowered, thus changing the state of each contactor. Depending on the type of contactors used, this may be, for example, a change in state from normally open to normally closed, either powering loads or depowering loads, depending on the contactor state and the state of the grid. Thus, depending on the nature of the contactor, for example, the signal to actuate the contactor may be either an applied voltage or a lack of applied voltage. ATS 242 may further operate to connect the alternative sources of power, as desired, in a manner similar to that described above.

As a further alternative, a wireless or remote signal may be used to actuate one or more contactors and/or connect to the alternative sources of power. It should be understood that such wireless and/or remote control may be applied to each of the embodiments described herein. As a non-limiting example, a wireless switch operable by a third party may be provided. As a further non-limiting example, a coil voltage trigger signal (12V-480V, for example, depending on the particular system and/or loads) may be provided. Thus, a “passive” system, such as in the embodiments of FIG. 13 and FIG. 14, for example, could be driven by a third party control device. Thus, in such a non-limiting example, control by a third party could be implemented through a wireless connection, such as a Wi-Fi connection or the like, and the analog controller 202 of the embodiment of FIG. 13 or the ATS 242 of the embodiment of FIG. 14 could be set to respond appropriately to switch the contactor(s) based on the wireless signal. It should be understood that such a wireless or remote controller does not have to be under the operation of a third party; i.e., such wireless or remote control could also be actuated by those actively involved in setting the analog controller 202 or the ATS 242. Alternatively, analog controller 202 or ATS 242 could be configured to be set remotely, rather than on-site. It should be further understood that any suitable number of wireless and/or remote controllers may be provided, and that any suitable number of wireless and/or remote-actuated switches for driving the contactors may also be used. As noted above, it should be understood that such a wireless and/or remote configuration may be applied to any of the embodiments described herein.

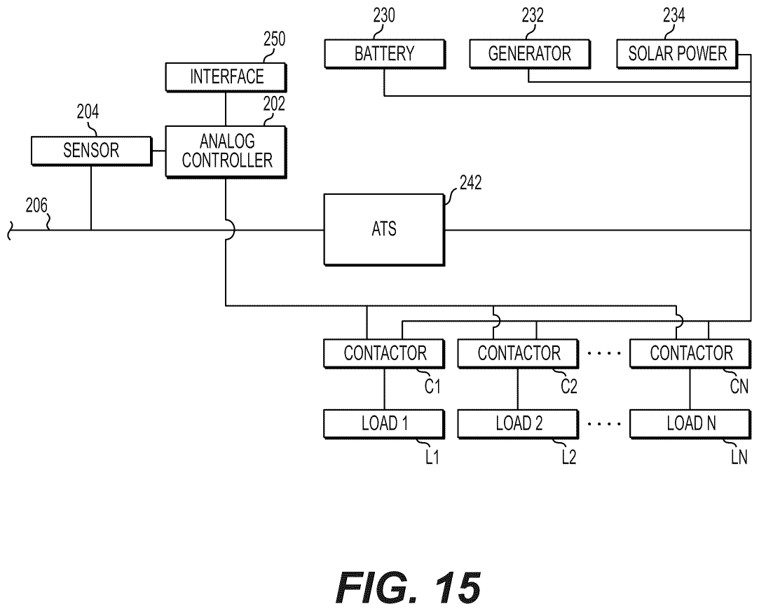

In the embodiment of FIG. 15, the analog controller 202 and sensor(s) 204 have been added to the configuration shown in FIG. 14, where the ATS 242 again operates in conjunction with analog controller 202. By feeding power from the grid (via line 206) into the sensor(s) 204, which may be voltage transformers, voltage sensors, or any other suitable type of power sensors, this arrangement allows power from the grid to be either used directly as a signal or as power to control the contactors. This power and/or signal is then conditioned via analog controller 202, which may be a passive Boolean logic controller or the like, to provide power to, or to remove power from, one or more of the contactors. The presence of the alternative sources of power 230, 232, 234 adds additional logic outcomes, depending on the state of power/control signal from both the alternative power sources 230, 232, 234 and the grid. It should be understood that an additional slave relay may be added to run the coils on the contactors, with the slave relay being controlled by analog controller 202. It should be further understood that the ATS 242 in any of the above embodiments may be replaced by a manual transfer switch (MTS). It should be further understood that analog controller 202 may be replaced by a digital controller, similar to controller 12, as described above, or the like.

It should also be understood that analog controller 202 and/or ATS 242 may be provided in any suitable physical form. As a non-limiting example, analog controller 202 and/or ATS 242 may be integrated into a conventional electrical panel. It should be further understood that sensor(s) 204 may be any suitable type of sensor(s) for detecting power-related conditions with respect to the utility grid via line 206. As a non-limiting example, a line voltage sensor may be provided on one or more of the L1, L2 and L3 legs of the incoming utility power. As another non-limiting example, a current sensor may be provided on one or more of the L1, L2 and L3 legs of the incoming utility power. Sensing via sensor(s) 204 may be performed either before the electric meter or after the electric meter on any available conductor.

It should be further understood that sensor(s) 204 in conjunction with analog controller 202 are not limited to only disconnecting the loads when there is a total lack of power from the electrical grid (e.g., a blackout). Any user-defined parameter may be used for setting analog controller 202. For example, analog controller 202 could be set based on a threshold value, only delivering a switching signal when a specific selectable or factory set voltage or current, for example, is reached. As another non-limiting example, rather than making a direct measurement from line 206, an indirect measurement of the voltage or current could be made, or either direct or indirect measurements of other effects, such as electromotive effects, could made. As an example, measuring radiofrequency (RF) emissions could be measured from the flow of electricity within the physical wires and/or circuits.

As discussed above, contactors C1, C2, C3, . . . CN may be any suitable type of contactors, or may be replaced by any suitable type of switches, switching circuits or the like. As further discussed above, depending on the type of contactors used, actuation may be, for example, a change in state from normally open to normally closed, either powering loads or depowering loads, depending on the contactor state and the state of the grid. Thus, depending on the nature of the contactor, for example, the signal to actuate the contactor may be either an applied voltage or a lack of applied voltage. As a non-limiting example, contactors C1, C2, C3, . . . CN may be two-pole (i.e., L1 and L2) devices capable of handling the amperage of the desired loads. As a further non-limiting example, contactors C1, C2, C3, . . . CN may be wired in between the circuit breaker protecting the circuit and the corresponding load. In this non-limiting example, a 40 A circuit breaker, as a further example, may be used to protect the wiring to a HVAC system. The two wires from that circuit breaker (L1 and L2) would be routed out of the main electric panel to the corresponding contactor. The output from the contactor would be routed back into the main electric panel where the wires to the HVAC system would be connected to the output from the contactor. For each of these L1 and L2 loads, two wires would be routed from the circuit breaker to the corresponding contactor, and two wires would be routed from that contactor to the wires connecting to the corresponding load.

It should be understood that the each of contactors C1, C2, C3, . . . CN does not have to be identical. As a non-limiting example, some of contactors C1, C2, C3, . . . CN could have a capacity of 40 Å on L1 and L2, and a remainder of the contactors could have a capacity of 60 Å on L1 and L2 (or L3 for a three phase application). For standard homes and small commercial structures, as a non-limiting example, the contactor coils would typically be activated with high voltage (i.e., 120-480 V) or low voltage (i.e., 12-24 V) signals coming from controller 202.

Through the setting of analog controller 202, a wide variety of options are available to the user. As a non-limiting example, when operating off of power from the electrical grid, the contactors C1, C2, C3, . . . CN would be normally closed as long as there is power feeding the contactor coils. If there is an interruption in grid power (e.g., a blackout), analog controller 202 could be set such that a selected number (from zero to all) contactors would open and backup power to the corresponding load(s) would be disabled. As another non-limiting example, analog controller 202 could be set such that the contactors C1, C2, C3, . . . CN would be normally open when fed by power from the electrical grid. When the electrical grid ceases supplying power (e.g., a blackout), the contactors C1, C2, C3, . . . CN would open and shed the respective loads to which they are attached. As further non-limiting examples, analog controller 202 could be set such that selected loads (from zero to all) remain permanently on regardless of grid status, selected loads (from zero to all) remain permanently off regardless of grid status, selected loads (from zero to all) are operated with a variable timing device or variable delay device, selected loads (from zero to all) are operated based on sensor(s) 204, as described above, or a combination of the above. In each of these non-limiting examples, analog controller 202 may act as a switching circuit, allowing selected loads to be re-enabled by closing the corresponding contactors to allow backup power to flow to the loads from alternative power sources 230, 232, 234.

Additionally, an interface 250 may be provided for both setting the analog controller 202 and also providing one or more indicators to show the state of operation of each load L1, L2, L3, . . . , LN. As non-limiting examples, the indicators associated with interface 250 may be multi-position switches, lights, electronic signals displayed on a display of interface 250 or the like. As another non-limiting example, interface 250 may be a wireless interface, allowing signals indicative of the state of operation of each load to be transmitted to one or more wireless devices.

It should be understood that when contactors C1, C2, C3, . . . CN open or close responsive to an appropriate signal (or lack of signal) from analog controller 202, they do not necessarily have to open or close instantaneously. As a non-limiting example, analog controller 202 could have set time delay for the opening or closing of contactors C1, C2, C3, . . . CN. As a further non-limiting example, the time delay could be implemented with a set sequence of openings (or closings) of particular ones of the contactors C1, C2, C3, . . . CN. For example, contactor C1 could be set to open first, followed by contactor C2, followed by contactor C3, etc. As a further non-limiting example, the sequential operation of the contactors could be implemented on its own, without the additional time delay function. It should be understood that both the time delay and the sequence may be user-selectable.

As discussed above, analog controller 202 may be any suitable type of controller, control circuit, or the like, or may, alternatively, be replaced by a digital controller, computer or the like. As a non-limiting example, analog controller 202 could include a relay powered by a low voltage or low current from sensor(s) 204. Such an exemplary relay would normally be closed when power flows from the electrical grid, but would open upon detection of a grid failure. Opening of this relay would interrupt power to one or more of contactors C1, C2, C3, . . . , CN.

As a non-limiting example of operation of any of the above embodiments, during normal grid operating conditions, power to all loads L1, L2, L3, . . . , LN in a house or the like would be provided by the utility power provided via line 206. Essential loads would be powered by the main busbar in the conventional circuit breaker panel, and routed through the existing circuit breaker for each respective load. Non-essential loads would be powered by the main busbar in the circuit breaker panel, routed through the existing circuit breaker, and then into a corresponding one of contactors C1, C2, C3, . . . , CN, and then to the corresponding one of loads L1, L2, L3, . . . , LN. Each contactor C1, C2, C3, . . . , CN in this example would be closed, allowing power to flow to the non-essential loads as long as the analog controller 202 is operating in the grid power state.

In this example, when there is an interruption in grid power (on L1, L2, L3 or any combination thereof), the sensor(s) 204 would detect this interruption, and analog controller 202 would operate to disconnect the power to the contactor coils, opening the contactors. When the contactors open, AC power to each load connected to each contactor would be disabled. Based on the settings of analog controller 230, selected ones of the contactors C1, C2, C3, . . . , CN could be closed again, with power routed to the corresponding selected loads from battery 230, generator 232, solar power system 234, or a combination thereof. When grid power is restored (detected by sensor(s) 204), power could then be switched back from the alternative sources of power 230, 232, 234 to the regular AC power coming from line 206. As discussed above, the contactors could be opened/closed all at once or could be restored sequentially with a timing device. Each contactor C1, C2, C3, . . . , CN may be operated manually (either directly or through analog controller 202), allowing the user to individually set each contactor in a desired mode. For example, each contactor may be selectable for operation in one of three modes: the contactor is turned off (i.e., no power flows to the load) in the event of an outage; the contactor is turned on (i.e., power flows to the load from the alternative sources of power) in the event of an outage; or the contactor is always turned off (and can be turned on again manually).

It should be understood that in any of the embodiments described herein, the system controller and/or ATS may be modified using switches, such as manual toggle switches, as a non-limiting example, to manually override the control signals being sent to the contactors. Thus, by use of such manual switches, or in combination with the controller and/or ATS, each load, or any desired particular loads, could be a) permanently switched on regardless of grid status; b) permanently kept off regardless of grid status; or c) operated with a variable timing device, a variable delay device, a grid voltage sensor, or a grid current sensor used as a single control input or used in combination. The inclusion of manually operated switches allows selected loads to be reenabled by closing the corresponding contactor(s) on one or more of the loads, thus allowing backup power to flow to the load connected to one or more of the contactors.

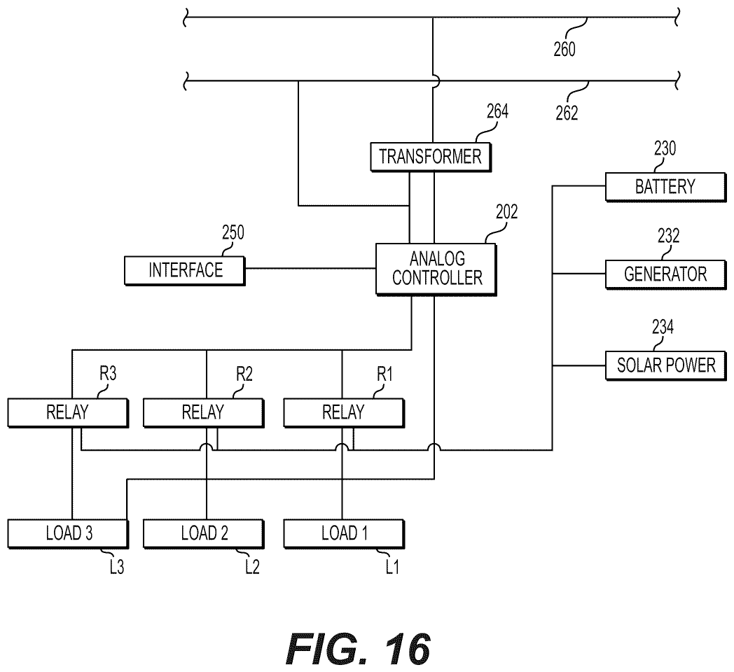

In the non-limiting example of FIG. 16, the analog controller 202 is integrated into a realistic household system, where the L1 line from the mains is indicated as 260 and the neutral line is indicated as 262. In order to switch to the alternate power sources in a manner which is generally compliant with local and federal regulations, transformer 264 is used, which may be a class 2 transformer for purposes of achieving compliance. In the simplified example of FIG. 16, only three loads L1, L2, L3 are shown, though it should be understood that this is for purposes of simplification and illustration only. The contactors of the previous embodiments are replaced by relays R1, R2, R3 in FIG. 16, although it should be understood that any suitable type of relays, contactors, switches, switching circuits, etc. may be used. For purposes of simplification, sensor(s) 204 are not shown in FIG. 16, although it should be understood that the non-limiting example of FIG. 16 operates in a manner similar to the previous embodiments.

As a realistic non-limiting example, for a single class transformer 264, relay R1 and relay R2 could each be 40 A relays, and relay R3 could be a 60 A relay. Such a system could be used with standard multivoltage input, ranging from 120 V to 480 V. As another realistic non-limiting example, the single class 2 transformer 264 could power multiple low power 24 VAC in combination with one or more larger relays for switching higher current loads.

It should be understood that in any of the embodiments described herein, the alternative sources of power are not necessarily directly connected to the electrical loads through the controller, control system and/or ATS; rather, the alternative sources of power may be connected to the electrical loads through separate equipment, such as a breaker panel or the like, and this breaker panel could either be associated with the energy management system or be supplied by a third party. In this non-limiting example, the breaker panel may be located immediately adjacent to the electrical loads and/or the energy management system or, alternatively, could supply power from a distance. As a further non-limiting example, this distanced power supply could be through an otherwise unrelated power panel on the other side of the house or the building in which the energy management system is installed. The arrangements described above would allow the power for the electrical loads to enter the controller, control system and/or ATS via the same lines as the utility power source, since the physical splits between the different power source lines would, most likely, occur in the breaker panel. This breaker panel could either be a separate panel or be incorporated into the enclosure housing the controller, control system and/or ATS of the energy management system.

Similarly, it should be understood that the switches, contactors or the like which perform the physical connection and disconnection of the electrical loads are not necessarily integrated into the same physical module or enclosure which houses the controller, control system and/or ATS of the energy management system. The actual physical connection and disconnection can take place either physically separated from the location of the controller, control system and/or ATS, or be integrated into the same physical module or enclosure. The flexibility described above allows the energy management system to be used with a variety of different power sources in a manner which requires no specific source of power to be used; i.e., the energy management system only controls which electrical loads are made available under different conditions and imposes no demands on any particular type or source of power used.

It is to be understood that the energy management system and method is not limited to the specific embodiments described above but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A method of managing power supplies, comprising the steps of:
providing a plurality of electrical loads connected to an electrical grid;
disconnecting a first user-defined sub-set of the electrical loads from the electrical grid upon detection of a predetermined condition, wherein the predetermined condition comprises a detected change in power from the electrical grid;
disconnecting a second user-defined sub-set of the electrical loads from the electrical grid upon detection of an environmental condition;
connecting at least one of the electrical loads from the first user-defined sub-set of the electrical loads to at least one alternative source of power when the predetermined condition is detected;
connecting at least one of the electrical loads from the second user-defined sub-set of the electrical loads to the at least one alternative source of power when the environmental condition is detected;
disconnecting the at least one of the electrical loads from the first user-defined sub-set of the electrical loads from the at least one alternative source of power when the predetermined condition is no longer detected;
disconnecting the at least one of the electrical loads from the second user-defined sub-set of the electrical loads from the at least one alternative source of power when the environmental condition is no longer detected;
reconnecting the first user-defined sub-set of the electrical loads to the electrical grid when the predetermined condition is no longer detected; and
reconnecting the second user-defined sub-set of the electrical loads to the electrical grid when the environmental condition is no longer detected.

2. The method of managing power supplies as recited in claim 1, wherein the predetermined condition comprises a detected change in line voltage from the electrical grid.

3. The method of managing power supplies as recited in claim 1, wherein the predetermined condition comprises a detected change in current from the electrical grid.

4. The method of managing power supplies as recited in claim 1, further comprising the step of providing an indication to a user of a state of operation of each of the electrical loads.

5. The method of managing power supplies as recited in claim 4, wherein the step of providing the indication to the user comprises wirelessly transmitting a signal to the user representative of the state of operation of each of the electrical loads.

6. The method of managing power supplies as recited in claim 1, wherein the step of disconnecting the user-defined sub-set of the electrical loads from the electrical grid is performed after a user-defined time delay.

7. The method of managing power supplies as recited in claim 1, wherein the step of connecting at least one of the electrical loads from the user-defined sub-set of the electrical loads to the alternative source of power is performed after a user-defined time delay.

8. The method of managing power supplies as recited in claim 1, wherein the step of disconnecting the user-defined sub-set of the electrical loads from the electrical grid is performed according to a user-defined sequence.

9. The method of managing power supplies as recited in claim 1, wherein the step of connecting at least one of the electrical loads from the user-defined sub-set of the electrical loads to the alternative source of power is performed according to a user-defined sequence.

10. The method of managing power supplies as recited in claim 1, wherein the environmental condition comprises availability of solar power.

11. The method of managing power supplies as recited in claim 1, further comprising the step of remotely selectively connecting or disconnecting at least one of the electrical loads.

12. A power supply management system, comprising:
a plurality of electrical loads connected to an electrical grid; and
a controller configured to:
disconnect a first user-defined sub-set of the electrical loads from the electrical grid upon detection of a predetermined condition, wherein the predetermined condition comprises a detected change in power from the electrical grid;
connect at least one of the electrical loads from the first user-defined sub-set of the electrical loads to at least one alternative source of power when the predetermined condition is detected;
connect at least one of the electrical loads from the second user-defined sub-set of the electrical loads to the at least one alternative source of power when the environmental condition is detected;
disconnect the at least one of the electrical loads from the first user-defined sub-set of the electrical loads from the at least one alternative source of power when the predetermined condition is no longer detected;
disconnect the at least one of the electrical loads from the second user-defined sub-set of the electrical loads from the at least one alternative source of power when the environmental condition is no longer detected;
reconnect the first user-defined sub-set of the electrical loads to the electrical grid when the predetermined condition is no longer detected; and
reconnect the second user-defined sub-set of the electrical loads to the electrical grid when the environmental condition is no longer detected.

13. The power supply management system as recited in claim 12, further comprising means for monitoring power supplied by the electrical grid.

14. The power supply management system as recited in claim 13, wherein the means for monitoring power comprises at least one voltage sensor.

15. The power supply management system as recited in claim 13, wherein the means for monitoring power comprises at least one current sensor.

16. The power supply management system as recited in claim 12, wherein the alternative source of power is selected from the group consisting of a battery, a solar power system, a generator, and combinations thereof.

17. The power management system as recited in claim 12, further comprising an automatic transfer switch in communication with the plurality of electrical loads.

18. The power management system as recited in claim 12, further comprising means for disconnecting the user-defined sub-set of the electrical loads from the electrical grid.

19. The power management system as recited in claim 18, wherein the means for disconnecting the user-defined sub-set of the electrical loads from the electrical grid comprise a plurality of electrical contactors.

20. The power management system as recited in claim 18, wherein the means for disconnecting the user-defined sub-set of the electrical loads from the electrical grid comprise a plurality of electrical relays.

21. The power management system as recited in claim 12, further comprising an interface for indicating to the user a state of operation of each of the electrical loads.

22. The power management system as recited in claim 12, wherein the environmental condition comprises availability of solar power.

23. The power management system as recited in claim 12, further comprising a remote controller for selectively connecting or disconnecting at least one of the electrical loads.
